(19) United States
(12) Patent Application Publication
(10) Pub. No.: US 2025/0335889 A1
(43) Pub. Date: Oct. 30, 2025

(54) SYSTEMS AND METHODS FOR STAGING AND CASTING A TRANSACTION BETWEEN DEVICES

(71) Applicant: Wells Fargo Bank, N.A., San Francisco, CA (US)

(72) Inventors: Jonathan Baker, San Francisco, CA (US); Frank DiGangi, San Francisco, CA (US); Nicolai J. Lesko, San Francisco, CA (US); Christian Mande, Charlotte, NC (US); Stephen George Mueller, San Francisco, CA (US); Heather Cobb Smith, San Francisco, CA (US); David Winner, San Francisco, CA (US)

(73) Assignee: Wells Fargo Bank, N.A., San Francisco, CA (US)

(21) Appl. No.: 18/648,230

(22) Filed: Apr. 26, 2024

(51) Int. Cl. G06Q 20/10; G06Q 20/40

(52) U.S. Cl. CPC G06Q 20/1085; G06Q 20/401

(57) ABSTRACT

A computing system includes at least one one or more automated teller machines (ATMs) and at least one processing circuit. The at least one processing circuit is configured to train an artificial intelligence (AI) model to determine predicted transactions of a user using transaction data related to a plurality of transactions of the user with the one or more ATMs; receive data indicative of a location of a user device corresponding to the user; determine a corresponding location of an ATM of the one or more ATMs; determine a predicted transaction of the user at the ATM using the AI model; and transmit information corresponding to the predicted transaction to the user device including an interface element to cast the predicted transaction to the ATM. The ATM is configured to receive transaction data cast by the user device to the ATM and execute a transaction according to the transaction data.

### TECHNICAL FIELD

The present disclosure relates apparatuses, systems, and methods for staging and casting transactions made via or with transaction devices, such as automated teller machines (ATMs).

### BACKGROUND

Automated Teller Machines (ATMs) are a convenient way for users (e.g., cardholders of a financial institution) to complete financial transactions, including document deposits, banknote deposits and the like. ATMs may be placed and accessed by users at various geographic locations, such as bank locations, convenience stores, other stores, or standalone kiosks to facilitate a user's interaction with the banking systems. Interacting with an ATM in order to complete a transaction, however, involves a user traveling to a location of an ATM capable of fulfilling the user's intended transaction. Additionally, interacting with the physical machine introduces security threats (e.g., to the user and/or to the user's sensitive information) and hassle for the user (e.g., inaccessibility for a handicapped user, visibility challenges due to glare, time spent navigating a display screen on the ATM, etc.).

### SUMMARY

One embodiment relates to a computing system. The computing system includes one or more automated teller machines (ATMs) and a provider computing system. The provider computing system includes a communication interface configured to communicate with the one or more ATMs and a user device, and at least one processing circuit coupled to the communication interface. The at least one processing circuit includes at least one processor coupled to at least one memory device. The at least one memory device stores instructions thereon that, when executed by the at least one processor, cause the at least one processing circuit to: train, for a user corresponding to the user device, an artificial intelligence (AI) model to determine predicted transactions of the user, using transaction data related to a plurality of transactions of the user with the one or more ATMs associated with the provider computing system; receive, via the communication interface from the user device, data indicative of a location of the user device; determine, based on the data indicative of the location of the user device, a corresponding location of an ATM of the one or more ATMs; determine, using the AI model, a predicted transaction of the user at the ATM, responsive to determining that a proximity between the location of the user device and the corresponding location of the ATM satisfies a threshold criteria; and transmit, via the communication interface, information corresponding to the predicted transaction to the user device, the user device displaying a user interface including an interface element to cast the predicted transaction to the ATM. The ATM is configured to: receive, from the user device, transaction data cast by the user device to the ATM; and execute a transaction according to the transaction data cast from the user device to the ATM.

Another embodiment relates to a method. The method includes: training, by a provider computing system, for a user corresponding to a user device, an artificial intelligence (AI) model to determine predicted transactions of the user, using transaction data related to a plurality of transactions of the user with one or more automated teller machines (ATMs) associated with the provider computing system; receiving, by the provider computing system, via the communication interface from the user device, data indicative of a location of the user device; determining, by the provider computing system, based on the data indicative of the location of the user device, a corresponding location of an ATM; determining, by the provider computing system, using the AI model, a predicted transaction of the user at the ATM, responsive to determining that a proximity between the location of the user device and the corresponding location of the ATM satisfies a threshold criteria; transmitting, by the provider computing system via the communication interface, information corresponding to the predicted transaction to the user device, the user device displaying a user interface including an interface element to cast the predicted transaction to the ATM; and performing, by the provider computing system responsive to a signal from the ATM indicating selection of the interface element, the predicted transaction.

Still another embodiment relates to a provider computing system. The provider computing system includes a communication interface configured to communicate with a user device and at least one processing circuit coupled to the communication interface. The at least one processing circuit includes at least one processor coupled to at least one memory device. The at least one memory device stores instructions thereon that, when executed by the at least one processor, cause the at least one processing circuit to: train, for a user corresponding to the user device, an artificial intelligence (AI) model to determine predicted transactions of the user, using transaction data related to a plurality of transactions of the user with one or more automated teller machines (ATMs); receive, from the user device, data indicative of a location of the user device; determine, based on the data indicative of the location of the user device, a corresponding location of an ATM; determine, using the AI model, a predicted transaction of the user at the ATM, responsive to determining that a proximity between the location of the user device and the corresponding location of the ATM satisfies a threshold criteria; transmit information corresponding to the predicted transaction to the user device, the user device displaying a user interface including an interface element to cast the predicted transaction to the ATM; and perform, responsive to a signal from the ATM indicating selection of the interface element, the predicted transaction.

Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention.

Moreover, additional features may be recognized in certain embodiments and/or implementations that may not be present in all embodiments or implementations.

### BRIEF DESCRIPTION OF THE DRAWINGS

FIG. 1 is a block diagram of a computing system, according to an example embodiment.

FIG. 2 depicts a block diagram of an AI sub-system of FIG. 1 in greater detail, according to an example embodiment.

FIG. 3 depicts a block diagram of an AI model of the AI sub-system of FIG. 1, according to an exemplary embodiment.

FIG. 4 is a flow diagram of a method to predict a transaction for a user to perform at an ATM, according to an example embodiment.

FIG. 5 is a flow diagram of a method to cast a transaction from a user device to a receiving system or device, such as an ATM, according to an example embodiment.

FIG. 6 is an illustration of a user interface including a predicted transaction and an option to cast the predicted transaction to a receiving system or device, according to an example embodiment.

### DETAILED DESCRIPTION

Aspects of this technical solution are described herein with reference to the figures, which are illustrative examples of this technical solution. The figures and examples below are not meant to limit the scope of this technical solution to the present implementations or to a single implementation, and other implementations in accordance with present implementations are possible, for example, by way of interchange of some or all of the described or illustrated elements. Where certain elements of the present implementations can be partially or fully implemented using known components, only those portions of such known components that are necessary for an understanding of the present implementations are described, and detailed descriptions of other portions of such known components are omitted to not obscure the present implementations. Terms in the specification and claims are to be ascribed no uncommon or special meaning unless explicitly set forth herein.

The systems, methods, computer-readable media, and apparatuses described herein relate to transaction optimization of transactions between a user and a transaction system, namely an ATM. As described herein, pre-staged transactions are improved using AI/machine learning, paired with user optimizations, to reduce ATM transaction friction and to improve a user's experience at the ATM. In particular, the systems, methods, computer-readable media, and apparatuses described herein relate to predicting transactions between the user and the ATM and allowing the user to cast a transaction to the ATM from a user device, such as a user mobile device. The user may cast the transaction, either a predicted transaction or a user-defined transaction, from the user's mobile device to the ATM. This casting feature enables users to use their mobile device to substantially complete an ATM transaction with minimal interaction with the ATM.

According to the various embodiments described herein, the systems, methods, and computer-readable media described herein relate to a technical solution of providing, using an artificial intelligence model, predicted transactions via a user's mobile device and presenting an option to cast the transaction from the user's mobile device to the ATM. Advantageously, the present disclosure saves time that a user would otherwise spend to set up the desired transaction, identify an ATM capable of performing the transaction, and interact with the ATM to perform the transaction. Rather, the systems, methods, computer-readable media, and apparatuses described herein provide the predicted transaction to an interface of the user's mobile device and suggest an ATM configured to perform the transaction. For example, if the predicted transaction includes a foreign currency withdrawal, the user interface may display a location of an ATM equipped with that foreign currency so that the user does not have to waste time and resources travelling to one or more ATMs that cannot perform the desired transaction. As another example, if the predicted transaction includes one or more preferred denominations of a user (e.g., with respect to a cash withdrawal), the user interface may display an ATM equipped with those preferred denominations.

By generating predicted transactions using an AI model, the AI model can predict transactions for the user based on user-specific data (e.g., one or more past interactions between that user and the ATM). In addition to using user-specific data, the training of the AI model can be fine-tuned further such that the AI model can predict transactions specific to one or more ATM locations and/or time frames. For example, the user may be notified that the AI model has generated a predicted transaction upon detecting that the user is close (e.g., within a predefined distance) to a particular ATM with which the user typically performs predicted transactions. As another example, the AI model may generate one or more predicted transactions based on a prior transaction history that suggests that the user routinely (e.g., more than a predefined number within a predefined time frame) makes a particular transaction at a specific time or on a specific date. In response, the system can transmit a notification to the user of the predicted transaction at the appropriate time, such as a predefined amount of time before or around that specific time and/or date.

The systems, methods, and computer-readable media described herein provide and describe various technical improvements to existing mechanisms for executing transactions (e.g., via a mobile application, in-person at an office location, using an ATM, etc.). By allowing a user to pre-stage a transaction between the user and an ATM, a provider institution, such as a financial institution, may have sufficient time between the time at which the transaction is pre-staged and the time at which the ATM performs the transaction to allow the ATM to perform the transaction. This technical improvement enables a foreign currency exchange at the ATM using pre-staging. For example, if a pre-staged transaction includes a foreign currency withdrawal, and the user pre-stages the transaction a predefined amount of time in advance of the desired transaction date and/or time (e.g., one week prior), then the provider institution has sufficient time (e.g., one week) to retrieve the foreign currency, if needed, and cause the foreign currency to be stocked/stored by the ATM before the user arrives to withdraw the foreign currency from the particular ATM. In this example, the user may reduce undesirable time-occupying activities, such as travelling to one or more ATMs that may not be configured to perform the pre-staged transaction (e.g., one or more ATMs that do not have the foreign currency indicated by the transaction).

Additionally, the systems, methods, and computer-readable media described herein provide and describe various technical improvements by allowing a user to select favorite transactions and pre-stage those selected favorite transactions with one click. This feature improves processing capacity and bandwidth, while reducing the networking power required to pre-stage and perform the transaction. For example, the user may otherwise have to first find the transaction (e.g., from a transaction history within a mobile device application or otherwise included on a user interface), identify an ATM capable of performing the transaction, and communicate the transaction to the ATM (e.g., by travelling to the ATM and instructing, via a display interface, the ATM to perform the transaction). As described below, however, the systems, methods, and computer-readable media of the present disclosure can automatically present suggested transactions to the user, identify one or more ATMs capable of performing each of the suggested transactions, and communicate the transaction to the ATM by casting the pre-staged transaction from the user device to the ATM.

Additionally, the systems, methods, and computer-readable media described herein address accessibility concerns associated with existing ATM technology. For example, glare on a display screen of an ATM hinders users from being able to view information related to a transaction request submitted to the ATM. As another example, users with various disabilities may experience additional hassle and difficulty while interacting with a physical ATM. These users may, for example, be unable to reach the physical ATM from within their vehicle and may not be able to independently adjust their position/exit the vehicle to reach the machine. Therefore, having the ability to pre-stage a transaction from their mobile device and cast the transaction to the ATM without physically interacting with the ATM minimizes the hassle that these users experience while attempting to interact with an ATM.

The systems, methods, and computer-readable media described herein offer solutions to these and other problems with the existing ATM technology by providing a method of pre-staging a transaction between a user and an ATM from a user device and casting the transaction to be performed by the ATM from the mobile device, which reduces the amount of time that a user spends interacting with a physical ATM in order to execute a transaction. For example, the amount of time that a user spends instructing the ATM regarding the transaction that the user intends to execute is reduced by suggesting the transaction via the user's mobile device and pre-staging the transaction on the mobile device (e.g., from a client application on their mobile device, as described in greater detail below). Therefore, the user can pre-stage the transaction prior to arriving at the ATM. With the casting feature, the user can cast the pre-staged transaction from their mobile device upon arrival at the ATM, thus eliminating any time that the user may otherwise spending at the ATM initiating the transaction.

Moreover, the systems, methods, computer-readable media, and apparatuses described herein provide multiple security benefits to transactions between a user and an ATM. For example, with the ability to cast a transaction to an ATM from a user's mobile device, the user can protect their sensitive account information. That is, rather than directly inputting sensitive information (e.g., a PIN code, a card number, an account number, etc.) via the ATM, which may be exposed to a member of the public (e.g., an individual other than the user), the sensitive information may be verified on the user's mobile device. In another instance, with the casting feature, a user who is a passenger in a vehicle approaching an ATM may avoid having to relay their sensitive information to a driver of the vehicle who then provides the sensitive information to the ATM. Rather, the passenger may be configured to pre-stage the transaction via their mobile device, perform authentication via their mobile device, and the ATM effectuate the transaction based on these actions. The driver, in turn, may only facilitate the exchange of certain physical items (e.g., withdrawn currency). To provide additional security in transactions with an ATM, the systems, methods, computer-readable media, and apparatuses described herein may reduce or minimize an amount of time that a user spends interacting with a physical ATM, which may reduce a risk presented by bad characters who may be lurking near the ATM. These security benefits may prove particular advantageous for single drivers alone in the car, at night, in unfamiliar areas, and so on. These and other features and benefits are described more fully herein below.

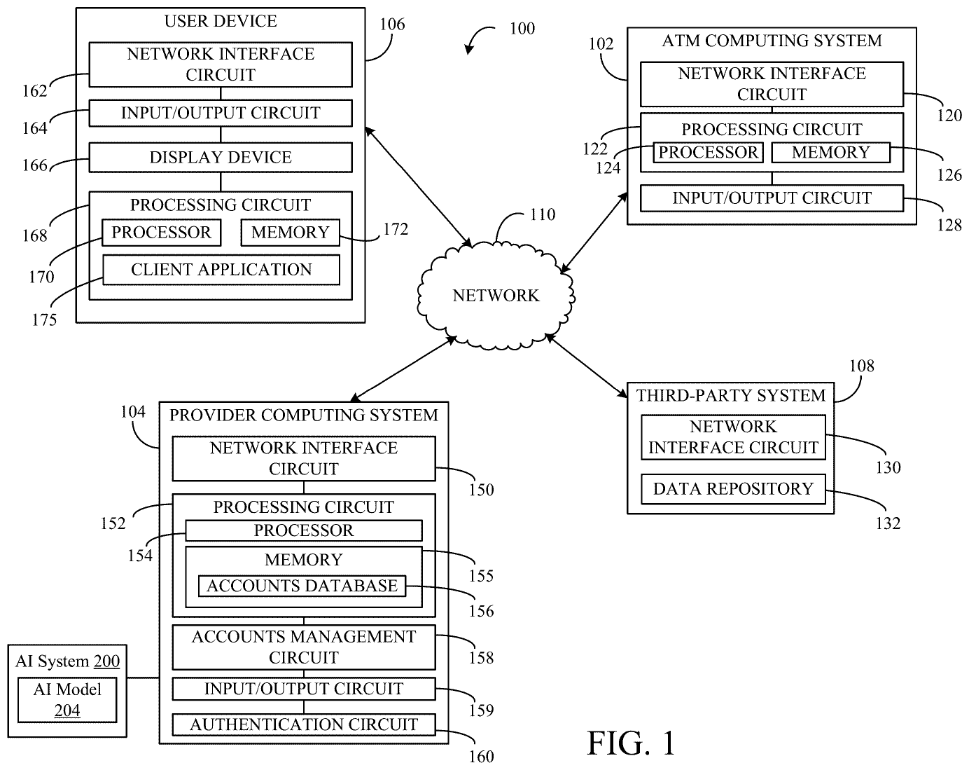

Referring now to FIG. 1, a system 100 for facilitating ATM transactions is shown, according to an example embodiment. The system 100 includes at least one ATM computing system 102 (also referred to as an ATM 102), a provider computing system 104, at least one user device 106 (shown as one user device 106, but there may be a plurality), and at least one third-party system 108 (shown as one third-party system 108, but there may be a plurality). The systems, devices, and/or components of the system 100 may be configured to communicate with each other over a network 110. The network 110 may include one or more of the Internet, cellular network, Wi-Fi®, Wi-Max, a proprietary banking network, or any other type of wired, wireless, or a combination of wired and wireless networks.

In some embodiments, the ATM computing system 102 includes a network interface circuit 120 that is configured to communicably couple the ATM 102 to the network 110. In which case, the ATM 102 may exchange information, via the network 110, with various computing systems, such as the user device 106 and/or the provider computing system 104. The ATM computing system 102 is configured to enable various ATM transactions, such as allowing a user to view account balances, purchase stamps, deposit checks, transfer funds, withdraw funds from a given account in the form of cash or other physical currency, and so on. For example, the ATM computing system 102 can include an ATM card slot configured to receive an ATM card inserted by a user. The ATM computing system 102 may include a currency dispenser that is used to dispense currency when a user performs, for example, a currency withdrawal. In some embodiments, the ATM computing system 102 is disposed at a brick-and-mortar facility associated with the provider institution. In other embodiments, the ATM computing system 102 is a standalone computing terminal (e.g., disposed at an office building, etc.). In the example shown, the ATM computing system 102 includes the at least one network interface circuit 120, at least one processing circuit 122, and at least one input/output circuit 128.

The network interface circuit 120 is configured or structured to establish connections to the network 110 by the ATM computing system 102 with, for example, the provider computing system 104 and/or the user device 106 (among potentially other computing systems). In some embodiments the network interface circuit 120 may be configured to establish communications via the network 110 with a third-party computing system (e.g., third-party system 108, as described below). For example, the third-party system 108 may include a computer system of a third-party provider institution separate from the provider institution (e.g., a separate financial institution, etc.). Thus, in this embodiment, the ATM is a network-connected ATM.

In some embodiments, the network interface circuit 120 may include one or more antennas or transceivers and associated communications hardware and logic (e.g., computer code, instructions, etc.). The network interface circuit 120 may also include program logic that is structured to allow the ATM computing system 102 to access and couple/connect to the network 110 to, in turn, exchange information with for example the provider computing system 104, the user device 106, one or more third-party systems 108, and/or other ATM systems (and potentially other systems/devices). That is, the network interface circuit 120 is coupled to processor 124 and memory 126 and configured to enable a coupling to the network 110. The network interface circuit 120 allows for the ATM computing system 102 to transmit and receive data/information over the network 110. Accordingly, the network interface circuit 120 includes any one or more of a cellular transceiver, a wireless network transceiver, and a combination thereof. Thus, the network interface circuit 120 enables connectivity to wide area networks (WANs) as well as local area networks (LANs). Further, in some embodiments, the network interface circuit 120 includes cryptography capabilities to establish a secure or relatively secure communication session between other systems such as the provider computing system 104, a second ATM computing system 102, the user device 106, the third-party system 108, etc. In this regard, information (e.g., account information, login information, financial data, digital objects, and/or other types of data) may be encrypted and transmitted to prevent or substantially prevent a threat of hacking or other security breach.

As shown in FIG. 1, the at least one processing circuit 122 of the ATM 102 includes at least one processor 124 and at least one memory 126. The processor 124 may be implemented as one or more processors, application specific integrated circuits (ASIC), one or more field programmable gate arrays (FPGAs), a digital signal processor (DSP), a group of processing components, or other suitable electronic processing components configured to perform the operations of the ATM computing system 102 described herein. The memory 126 is structured to retrievably store information regarding accounts held by various users. The account information (or selective portions thereof) may be stored by the memory 126 and/or stored by an accounts database that provides the ATM or that is coupled to the ATM (e.g., accounts database 156 of the provider computing system 104). For instance, the memory 126 may store information related to the financial account of the user, such as authentication information (e.g., username/password combinations, personal identification numbers (PINs), device authentication tokens, security question answers, account information, balances, biometric data, etc.). Furthermore, the memory 126 may store any other information that may be encountered in the operation of an ATM with expanded functionalities as described herein, such as user preferences and other information comprising a user profile, transaction history, etc. The memory 126 may also store information regarding how to operate the ATM. For example, the information regarding how to operate the ATM may include screens to display via the ATM, prompts to provide via the ATM, instructions to actuate certain devices associated with the ATM (e.g., when to open a currency drawer, etc.), error codes that may be triggered, and data to send to backend systems (e.g., the provider computing system 104), among other operational/functional control processes. The processing circuit 122 may perform or assist in performing any of the operations, processes, or methods discussed herein.

The at least one input/output circuit 128 (e.g., the I/O circuit 128) is structured to receive communications from and provide communications to other computing devices, users, and the like associated with the ATM computing system 102. The I/O circuit 128 is structured to exchange data, communications, instructions, and the like with an input/output device(s) of the ATM 102. In some arrangements, the I/O circuit 128 includes communication circuitry for facilitating the exchange of data, values, messages, and the like between the I/O circuit 128 and the components of the ATM computing system 102. In some arrangements, the I/O circuit 128 includes machine-readable media for facilitating the exchange of information between the I/O circuit 128 and the components of the provider computing system 104, the user device 106, and/or the third-party system 108. In some arrangements, the I/O circuit 128 includes any combination of hardware components, communication circuitry, and machine-readable media.

In some arrangements, the I/O circuit 128 includes suitable input/output ports and/or uses an interconnect bus for interconnection with a local display (e.g., a liquid crystal display, a touchscreen display) and/or keyboard device (when applicable), or the like, serving as a local user interface for programming and/or data entry, retrieval, or other user interaction purposes. As such, the I/O circuit 128 may provide an interface for the user to interact with various applications and/or executables stored, hosted, or otherwise provided on the ATM computing system 102. For example, the I/O circuit 128 may include or be coupled to a keyboard, a keypad, a touch screen, a microphone, a biometric device, and the like. As another example, I/O circuit 128, may include or be coupled to, a monitor, a printer, a speaker, and so on.

The provider computing system 104 may be or include a computing system associated with an entity or provider institution, such as a financial institution, capable of maintaining user accounts (e.g., ATM card accounts, etc.) and databases of user information. In the example shown, the provider institution is a financial institution. The financial institution may include commercial or private banks, credit unions, investment brokerages, or other financial institutions. The provider computing system 104 may maintain a plurality of user accounts having various information. In the example shown, the provider institution is an issuer of ATM cards (e.g., a debit card) for users of the provider institution to use at the ATM.

In the example shown, the provider computing system 104 is structured as a backend computing system that may comprise one or more servers. The provider institution may provide or support the ATM computing system 102 (e.g., manufacture or cause manufacturing of the ATM computing system 102 and ATM(s), facilitate access to accounts maintained by the provider computing system 104 via the ATM computing system 102, etc.). In some embodiments, the provider computing system 104 is structured to permit, facilitate, manage, process, and allow ATM transactions via communication with the user device 106 and/or the ATM computing system 102. The provider computing system 104 may store information relating to a user account, as it may be used to predict and/or execute an ATM transaction via the ATM computing system 102. For example, the provider computing system 104 may store information relating to checking accounts, savings accounts, withdrawals of funds, deposits of funds, storage/exchanges of non-monetary media, and so on. As will be appreciated, the level of functionality that resides on the provider computing system 104 as opposed to the ATM computing system 102 may vary depending on the implementation of this disclosure. As shown, the provider computing system 104 includes at least one network interface circuit 150, at least one processing circuit 152, an accounts management circuit 158, an input/output circuit 159, and an authentication circuit 160.

The at least one network interface circuit 150 is structured to couple to the network 110 to enable communications with the ATM computing system 102, the user device 106, and/or the third-party system 108, among potentially other systems and devices. In some embodiments, the network interface circuit 150 includes programming and/or hardware-based components that connect the provider computing system 104 to the network 110. The network interface circuit 150 may be coupled to the processing circuit 152 to enable the processing circuit 152 to receive and transmit messages, data, and information via the network 110. In some embodiments, the network interface circuit 150 may include one or more antennas or transceivers and associated communications hardware and logic (e.g., computer code, instructions, etc.). The network interface circuit 150 may also include program logic that is structured to allow the provider computing system 104 to access and couple/connect to the network 110 to, in turn, exchange information with, for example, the user device 106, the ATM computing system 102, and/or the third-party system 108 (and potentially other systems/devices). The network interface circuit 150 allows for the provider computing system 104 to transmit and receive data over the network 110. Accordingly, the network interface circuit 150 includes any one or more of a cellular transceiver (e.g., CDMA, GSM, LTE, etc.), a wireless network transceiver (e.g., 802.11X, ZigBee, WI-FI, Internet, etc.), and a combination thereof (e.g., both a cellular transceiver and a wireless transceiver). Thus, the network interface circuit 150 enables connectivity to WAN as well as LAN (e.g., Bluetooth, near field communication (NFC), etc. transceivers). Further, in some embodiments, the network interface circuit 150 includes cryptography capabilities to establish a secure or relatively secure communication session between other systems such as the user device 106, the ATM computing system 102, the third-party system 108, etc. In this regard, information (e.g., account information, login information, financial data, digital objects, and/or other types of data) may be encrypted and transmitted to prevent or substantially prevent a threat of hacking or other security breach. To further support features of or interaction with the provider computing system 104, the network interface circuit 150 may provide a relatively high-speed link to the network 110.

The at least one processing circuit 152 is shown to include at least one processor 154 and at least one memory 155 and may be communicably connected to the network interface circuit 150, the accounts management circuit 158, the input/output circuit 159, and the authentication circuit 160. The processing circuit 152 may perform or assist in performing any of the operations, processes, or methods discussed herein. The processor 154 may be implemented as one or more processors, application specific integrated circuits (ASIC), one or more field programmable gate arrays (FPGAs), a digital signal processor (DSP), a group of processing components, or other suitable electronic processing components configured to perform the operations of the provider computing system 104 described herein. The memory 155 includes one or more memory devices (e.g., RAM, NVRAM, ROM, Flash Memory, hard disk storage) that store data and/or computer code for facilitating the various processes described herein. That is, in operation and use, the memory 155 stores at least portions of instructions and data for execution by the processor 154 to perform various operations. The memory 155 may be or include tangible, non-transient volatile memory and/or non-volatile memory.

The provider computing system 104 may include, maintain, or otherwise access an accounts database 156. While shown stored in the memory 155 in FIG. 1, in other embodiments, the accounts database 156 may be a separate component/system relative to the memory 155. The accounts database 156 is structured to retrievably store information regarding accounts held by users (e.g., customers, clients, etc.) of the provider institution. For example, the accounts database 156 may store information regarding a debit account held by a user of the provider institution (e.g., a card number). As another example, the accounts database 156 may store information related to the user, the user device 106, and/or the ATM computing system 102. For example, the accounts database 156 may store authentication information (e.g., username/password combinations, device authentication tokens, security question answers, OTPs, PINs, biometric information, etc.), user information (e.g., name, date of birth, etc.), account information (e.g., account number, balance information, expiration date, etc.), identifiers of ATM storage repositories that are occupied/unoccupied, logs of items received via ATM storage repositories in exchange for currency, and so on. The accounts database 156 may store within the user's client account all or mostly all of the items that the user has registered with the provider computing system 104, including user data (e.g., personal information, account numbers, bill and payment histories, communications sent and received from the user, etc.). In various embodiments, the accounts database 156 is structured as one or more remote data-storage facilities (e.g., cloud servers).

The accounts management circuit 158 is structured to manage the financial accounts of various users, including maintaining and handling transaction processing for one or more accounts of the users. Accordingly, the accounts management circuit 158 is configured to process payments made from an account of the user held at the provider institution associated with the provider computing system 104. Further, the accounts management circuit 158 is configured to process deposits/withdrawals that a user makes into/from the user's account via the ATM 102. In some embodiments, the accounts management circuit 158 is configured to manage financial accounts of entities, individuals, organizations, charities, or other suitable parties that may receive deposits from users at one or more designated ATMs, one or more ATMs within a designated geographic region, etc.

Like the I/O circuit 128, the input/output circuit 159 (e.g., I/O circuit 159) is structured to receive communications from and provide communications to other computing devices, users, and the like associated with the provider computing system 104. The I/O circuit 159 is structured to exchange data, communications, instructions, and the like with an input/output device of the components of the system 100. In some arrangements, the I/O circuit 159 includes any combination of hardware components, communication circuitry, and machine-readable media for facilitating the exchange of data, values, messages, and the like between the I/O circuit 159 and the components of the provider computing system 104 and/or the system 100.

In some arrangements, the I/O circuit 159 includes suitable input/output ports and/or uses an interconnect bus for interconnection with a local display (e.g., a liquid crystal display, a touchscreen display) and/or keyboard/mouse devices (when applicable), or the like, serving as a local user interface for programming and/or data entry, retrieval, or other user interaction purposes. As such, the I/O circuit 159 may provide an interface for the user to interact with various applications and/or executables stored on the provider computing system 104.

The authentication circuit 160 is configured or structured to authenticate users. For example, the authentication circuit 160 may be structured to authenticate users attempting to access the ATM 102 to perform transactions (e.g., that the received user information matches stored user information associated with an account at the provider institution). In this way, the authentication circuit 160 is configured to prevent unauthorized access to user accounts (e.g., checking accounts, saving accounts, etc.). The authentication circuit 160 may receive input data from the ATM computing system 102, such as account numbers, account identifiers, username and password combinations, passcodes, biometric data and the like related to the identity of the ATM user. The authentication circuit 160 may compare data received from the ATM user with user information stored in the accounts database 156 of the provider computing system 104. In some embodiments, the authentication circuit 160 may permit access to specific ATM functionalities based on respective user account data, privileges, and permissions. For example, a withdrawal limit associated with a user's account may prevent the user from being able to withdraw an amount of currency from the ATM 102 that is above the withdrawal limit. The authentication circuit 160 may also store or track information about user access, authentication attempts, and transaction details associated with one or more ATMs. Additionally, the authentication circuit 160 may obtain information from various sources (e.g., by sending a text to the user device 106 with a verification code, by receiving inputs from the ATM, etc.) to authenticate a new user of the ATM computing system 102.

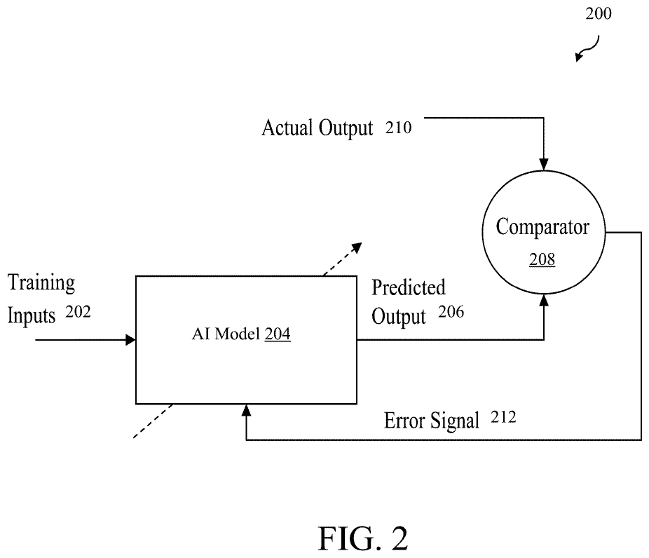

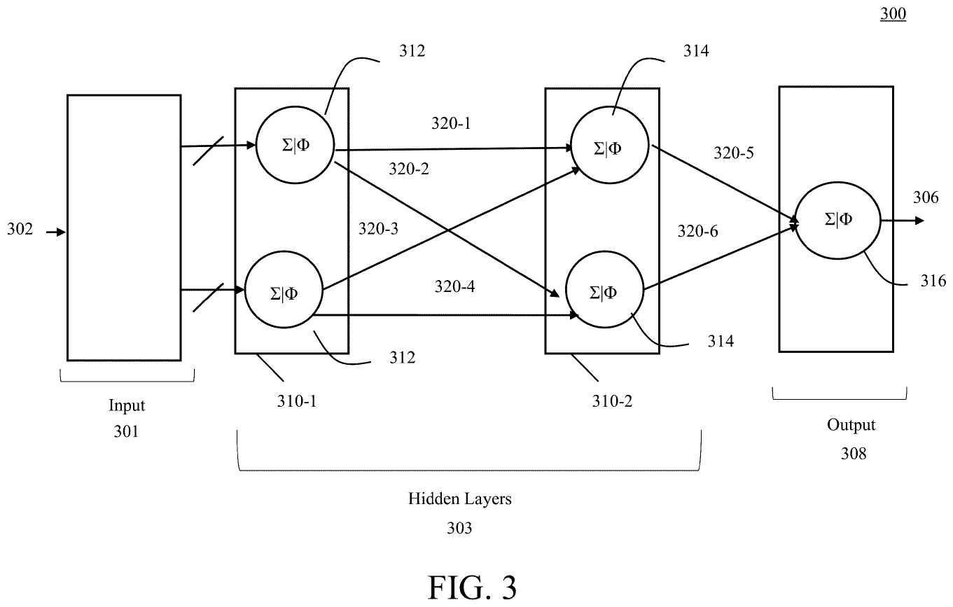

.In some embodiments, the provider computing system 104 may include or otherwise be coupled to an AI system 200 including one or more AI models 204, as described in greater detail below with reference to FIGS. 2 and 3. The AI system 200 may include one or more servers, databases, or cloud computing environments that may execute one or more AI models as described herein (e.g., AI model 204, as described in greater detail below with reference to FIGS. 2-3). The one or more AI models may include, but are not limited to, large language models (LLMs), which can be trained to generate human-like text, speech, images, and/or components of graphical user interfaces. The one or more AI models may be structured using a deep learning architecture that includes a multitude of interconnected layers, including attention mechanisms, self-attention layers, and transformer blocks. The one or more AI models are trained on large datasets to assimilate patterns, structures, and relationships within the data. The trained one or more AI models can be trained to generate outputs that resemble or closely resemble the characteristics of the input data. For example, the one or more AI models may be trained to predict one or more ATM transactions associated with a user that resemble or closely resemble the characteristics (e.g., parameters) of an input transaction associated with the user. The one or more AI models may be fine-tuned to generate specific output data, including data that is compatible with various database architectures or provider computing systems. The one or more AI models can be trained via optimization of a large number of parameters, in which the one or more AI models learn to minimize the error between its predictions and the actual data points, resulting in highly accurate and coherent generative capabilities.

The user device 106 may include any type of user computing device associated with an ATM user. The user may be an individual (e.g., a customer or a non-customer of the provider institution associated with the provider computing system), a business entity representative, a government entity representative, and so on. The user device 106 is structured to exchange data over the network 110, execute software applications, access websites, generate graphical user interfaces, and perform various of the operations described herein. The user device 106 may include one or more of a smartphone or other cellular device, a wearable computing device (e.g., a watch or bracelet, etc.), a tablet, a portable gaming device, a laptop, and other portable computing devices. In the example shown, the user device is structured as a mobile device and, namely, a smartphone.

The user device 106 includes a network interface circuit 162, at least one input/output circuit 164, a display device 166, and at least one processing circuit 168. The network interface circuit 162 is configured or structured to establish connections via the network 110 between the user device 106, the ATM computing system 102, the provider computing system 104, and the third-party system 108, similar to the network interface circuits discussed above (e.g., network interface circuit 120, network interface circuit 150). The at least one processing circuit 168 includes at least one processor 170 and at least one memory 172.

The network interface circuit 162 is structured to receive communications from and provide communications to the user of the user device 106 (e.g., via the processing circuit 168 and I/O device(s)) associated with a transaction at the ATM. The network interface circuit 162 includes hardware and associated logic (e.g., instructions, computer code, etc.) to enable the user device 106 to exchange information with other devices (e.g., the provider computing system 104, the ATM computing system 102, the third-party system 108) that may interact with the user device 106. The information may refer to authentication credentials including a passcode, key, command, or the like to perform one or more transactions with the ATM.

The input/output circuit 164 (e.g., I/O circuit 164) may include any combination of hardware components, for example, a mechanical keyboard, a touchscreen, a microphone, a camera, a fingerprint scanner, a device that is able to be coupled to the user device 106 via a connection (e.g., USB, serial cable, Ethernet cable, etc.), and so on. The output aspect of the I/O circuit 164 allows the user to receive information from the user device 106, and may include, for example, a digital display, a speaker, illuminating icons, light emitting diodes (“LEDs”), and so on. Thus, the I/O circuit 164 may include systems, components, devices, and apparatuses that serve both input and output functions; only input functions; and/or only output functions. The I/O circuit 164 may include communication circuitry for facilitating the exchange of data, values, messages, and the like between an input and/or output device and the components of the user device 106.

In some embodiments, the display device 166 may be a screen, such as a touchscreen or another display device. The user device 106 may communicate information to the user via a user interface displayed or rendered on the display device 166 and/or to receive communications from the user (e.g., through a keyboard provided on the display device 166). In some embodiments, the display device 166 may be a component of the I/O circuit 164, as described above.

The user device 106 may include at least one processing circuit 168, which may, as an example, at least one processor 170 and at least one memory 172. The user device 106 may also include at least one client application, including client application 175, which is described below. The processor 170 can include a microprocessor, an ASIC, an FPGA, a GPU, a TPU, etc., or combinations thereof. The memory 172 can store processor-executable instructions that, when executed by the processor 170, cause the processor 170 to perform one or more of the operations described herein. The memory 172 can include, but is not limited to, electronic, optical, magnetic, or any other storage or transmission device capable of providing the processor with program instructions. The memory 172 can further include a memory chip, ROM, RAM, EEPROM, EPROM, flash memory, optical media, or any other suitable memory from which the processor 170 can read instructions. The instructions can include code from any suitable computer programming language.

The client application 175 can be coupled to and supported, at least partly, by the provider computing system 104. In some embodiments, the client application 175 includes program logic stored in a system memory (e.g., memory 172) of the user device 106. In such arrangements, the program logic may configure a processor (e.g., processor 170) of the user device 106 to perform at least some of the functions discussed herein with respect to the client application 175 of the user device 106. In the example shown, the client application 175 may be downloaded from an application store, stored in the memory 172 of the user device 106, and selectively executed by the processor 170. In other embodiments, the client application 175 may be hard coded into the user device 106. In still various other embodiments, the client application 175 is a web-based application.

As described above, the client application 175 may be provided by the provider associated with the provider computing system 104 such that the client application 175 supports at least some of the functionalities and operations described herein with respect to the provider computing system 104. For example, in operation, the client application 175 can be communicably coupled to the provider computing system 104 and may perform certain operations described herein, such as generating a predicted transaction and presenting an option to cast the predicted transaction to an identified ATM from the user device 106 via the client application 175, and so on. In this way, the client application 175 may also be referred to as a provider institution client application or provider client application. In some embodiments, the client application 175 may be accessed and executed by the processor 170 responsive to receiving various credentials of a user to access the client application 175 (e.g., a username, a password, a pin code, a biometric such as a facial scan or a fingerprint, a combination thereof, etc.). In some embodiments, the client application 175 may be configured to store one or more favorite transactions designated by the user. The client application 175 may be configured to present, via a graphical user interface on the user device 106, the one or more favorite transactions such that the user may pre-stage any of the one or more favorite transactions for processing by the ATM 102/provider computing system 104. For example, the user may click on a depiction of any of the one or more favorite transactions via the user device 106 to pre-stage the corresponding transaction.

In some instances, the client application 175 may additionally be coupled to the third-party system 108 (e.g., via one or more application programming interfaces (APIs) and/or software development kits (SDKs)) to integrate one or more features or services provided by the third-party system 108. In some instances, the third-party system 108 may alternatively and/or additionally provide services via a separate client application 175.

The user device 106 can access various functions of the provider computing system 104 through the network 110. For example, the user device 106 can access one or more functions of the provider computing system 104 via the client application 175 of the user device 106 that is configured to display various user interfaces depicting information relating to the user account stored by the provider computing system 104 (e.g., transactions performed involving the user account(s), etc.) to the user device 106 via the network 110. As described in greater detail herein, a user of the user device 106 can select at least one output within the client application 175 of the user device 106 (e.g., via at least one selectable element presented on a user interface of the user device 106). The provider computing system 104 can determine, using one or more AI models 204, as described herein, at least one recommendation based on the at least one selected output and render responses on the user device 106 via the client application 175.

In some embodiments, the system 100 may include at least one third-party system 108 (shown as one third-party system 108, but there may be any number of third-party systems 108). The third-party system 108 refers to an institution (e.g., a provider entity, such as a financial institution) that is a third-party relative to the provider institution associated with the provider computing system 104. Furthermore, the institution associated with the third-party system 108 may be an institution at which a user accessing the provider computing system 104 has an account. In some embodiments, the third-party system 108 may be configured to transmit data relating to the user to the provider computing system 104, but may not be configured to access data related to other users from the provider computing system 104. For example, the third-party system 108 may be a financial institution separate from the financial institution associated with the provider computing system 104. The third-party system 108 may be configured to provide information relating to one or more accounts associated with the user to the provider computing system 102, however, the third-party system 108 may not receive information relating to the one or more accounts of the user held at the financial institution associated with the provider computing system 102. In still other embodiments, the third-party system 108 may include a credit bureau, a government institution, or any other institution that may house information related to the user (e.g., information used as training inputs 202 and actual outputs 210, as described below with reference to FIG. 2). As shown in FIG. 1, the third-party system 108 includes network interface circuit 130 and a data repository or database 132. The network interface circuit 130 may be configured to facilitate exchanging data with the ATM computing system 102, the provider computing system 104, and/or the user device 106 through the network 110. The third-party system 108 may include one or more servers. The third-party system 108 may include one or more APIs and/or SDKs associated with the third-party entity for exchanging data with the provider computing system 104 and/or the user device 106, as described herein. The data repository 132 refers to a database including data related to a user's activity with the third-party system 108 (e.g., account information, financial transactions, account balances, etc.).

Referring to FIG. 2, a block diagram of the AI system 200 using supervised learning is shown, according to an example embodiment. Supervised learning is a method of training an AI model given input-output pairs. An input-output pair is an input with an associated known output (e.g., an expected output). More specifically, an AI model 204 may provide a method of supervised learning that, upon being trained by a plurality of input-output pairs, is configured to generate outputs based on unknown inputs. The AI model 204 may be structured to recognize patterns, trends, and the like in data and make one or more determinations.

The AI model 204 may be trained on known input-output pairs such that the AI model 204 can learn how to predict known outputs given known inputs. Once the AI model 204 has learned how to predict known input-output pairs, the AI model 204 can operate on unknown inputs to predict an output. The AI model 204 may be trained based on general data and/or granular data (e.g., data based on a specific user) such that the AI model 204 may be trained specific to a particular user (e.g., a user with a user account at the provider institution).

Training inputs 202 and actual outputs 210 may be provided to the AI model 204. Training inputs 202 may include one or more transaction parameters, contextual information, and the like. Actual outputs 210 may include one or more previous transactions, patterns among a history of transactions, and the like. The training inputs 202 and actual outputs 210 may be received from one or more data sources of the system 100. The one or more data sources may include one or more internal data sources (e.g., the memory 126, the memory 155, the accounts database 156, etc.) and/or one or more external data sources (e.g., the user device 106, the data repository 132 of the third-party system 108, etc.). The one or more internal data sources may be accessible within the provider computing system 104. The one or more external data sources may be accessible over the network 110. For example, the one or more internal data sources may provide account information associated with a user, a transaction history, and so on. The one or more external data sources may provide parameters surrounding a transaction request (e.g., submitted by a user via the client application 175 on the user device 106), account information (e.g., stored in the accounts database 156), contextual information (e.g., stored in the data repository 132), and so on. In some embodiments, the parameters surrounding the transaction request may include a transaction type, a transaction amount, a sending party, a receiving party, one or more denominations associated with the transaction, a currency, etc. Thus, the AI model 204 may be trained to predict one or more transactions based on the training inputs 202 and the actual outputs 210 used to train the AI model 204.

The AI model 204 may be trained on large datasets (e.g., training inputs 202, actual outputs 210) to assimilate patterns, structures, and relationships within the data (e.g., within the account information associated with the user, the transaction history, the parameters surrounding the transaction request, the contextual information, etc.). The trained AI model 204 may be trained to generate outputs (e.g., predicted output 206) that resemble or closely resemble the characteristics of the input data (e.g., training inputs 202, actual outputs 210). For example, the AI model 204 may be trained to predict one or more transactions that resemble or closely resemble the characteristics (e.g., parameters) of an input transaction (e.g., one or more transactions included in a transaction history associated with the user). That is, the AI model 204 may learn the transaction history associated with the user and may be configured to suggest transactions to the user (e.g., using generative AI, as described below) based on the transaction history.

In some embodiments, the AI model 204 may include one or more generative AI models. The generative AI models may include, but are not limited to, large language models (LLMs), which can be trained to generate human-like text, speech, images, and/or components of graphical user interfaces. The generative AI models may be structured using a deep learning architecture that includes a multitude of interconnected layers, including attention mechanisms, self-attention layers, and transformer blocks. The generative AI models may be fine-tuned to generate specific output data, including data that is compatible with various database architectures or provider computing systems. The generative AI models can be trained via optimization of a large number of parameters, in which the generative AI models learn to minimize the error between its predictions and the actual data points, resulting in highly accurate and coherent generative capabilities.

In some embodiments, the AI model 204 may be trained to make one or more recommendations (e.g., one or more recommendations regarding or associated with one or more predicted transactions). That is, the AI model 204 may be trained using the training inputs 202, such as the parameters surrounding the transaction request, to predict outputs 206, such as one or more predicted transactions, by applying the current state of the AI model 204 to the training inputs 202. The current state of the AI model 204 refers to the predictive capacity of the AI model 204 based on the training that the AI model 204 has received thus far. For example, when a user first enrolls in an account at the provider institution, the current state of the AI model 204 may be one that has not been trained using data particular to that user, so the predictive capacity of the AI model 204 may be less accurate than the predictive capacity of the AI model 204 once the user has engaged in a plurality of transactions with the provider institution. The comparator 208 may compare the predicted outputs 206 to actual outputs 210 (e.g., one or more previous transactions) to determine an amount of error or differences. The actual outputs 210 may be determined based on historic data associated with the recommendation to the user.

During training, the error (represented by error signal 212) determined by the comparator 208 may be used to adjust the weights in the AI model 204 such that the AI model 204 changes (or learns) over time. The AI model 204 may be trained using a backpropagation algorithm, for instance. The backpropagation algorithm operates by propagating the error signal 212. The error signal 212 may be calculated each iteration (e.g., each pair of training inputs 202 and associated actual outputs 210), batch and/or epoch, and propagated through the algorithmic weights in the AI model 204 such that the algorithmic weights adapt based on the amount of error. The error is minimized using a loss function. Non-limiting examples of loss functions may include the square error function, the root mean square error function, and/or the cross-entropy error function.

The weighting coefficients of the AI model 204 may be tuned to reduce the amount of error, thereby minimizing the differences between (or otherwise converging) the predicted outputs 206 and the actual outputs 210. The AI model 204 may be trained until the error determined at the comparator 208 is within a certain threshold (or a threshold number of batches, epochs, or iterations have been reached). The trained AI model 204 and associated weighting coefficients may subsequently be stored in a training database, as described below, such that the AI model 204 may be employed on unknown data (e.g., not training inputs 202). Once trained and validated, the AI model 204 may be employed during a testing (or an inference phase). During testing, the AI model 204 may ingest unknown data to predict future data (e.g., one or more predicted transactions).

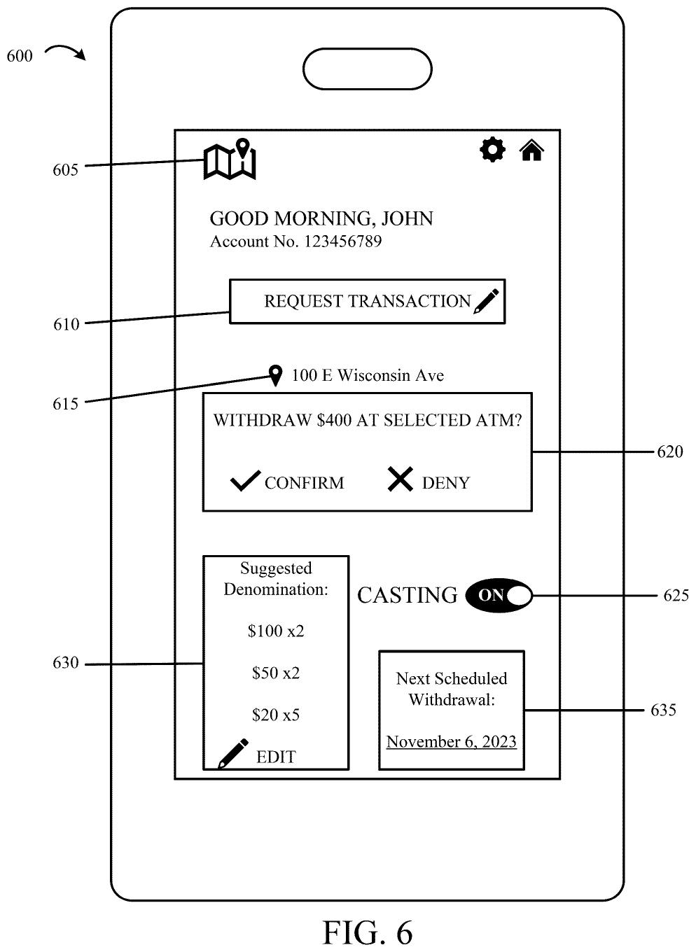

In some embodiments, the AI model 204 may include at least one generative artificial intelligence (AI) model. The at least one generative AI model may include, but is not limited to, a large language model (LLM), which can be trained to generate human-like text, speech, images, or components of graphical user interfaces (e.g., components of graphical user interface 600, as described below with reference to FIG. 6, respectively). The at least one generative AI model may be structured using a deep learning architecture that includes a multitude of interconnected layers, including attention mechanisms, self-attention layers, and transformer blocks. The at least one generative AI model is trained on large datasets to assimilate patterns, structures, and relationships within the data. The trained at least one generative AI model can be trained to generate outputs that closely resemble the characteristics of the input data. For example, if the input data includes a transaction history regarding one or more transactions between a user and an ATM, the generated outputs may include predicted transactions that closely resemble the one or more transactions in the transaction history. The at least one generative model may be fine-tuned to generate specific output data, including data that is compatible with various database architectures or augmented reality systems. The at least one generative AI model can be trained via optimization of a large number of parameters, in which the at least one generative AI model learns to minimize the error between its predictions and the actual data points, resulting in highly accurate and coherent generative capabilities.

In the specific context of LLMs, the at least one generative AI model can operate through a process of tokenization, wherein input text (e.g., text from at least one of the training inputs 202 and/or the actual outputs 210) is divided into individual tokens that represent words or sub-word units. The generated tokens are then embedded into a high-dimensional vector space, which enables the at least one generative AI model to capture and encode the semantic and syntactic relationships among the tokens. The transformer architecture facilitates the simultaneous processing of these tokens, effectively capturing dependencies and relationships across different parts of the input sequence. Self-attention mechanisms enable the at least one generative AI model to weigh the importance of each token in relation to others within the context, refining the representation of the input text data. Upon generating the output, the model selects tokens sequentially based on the highest probability of occurrence, as determined by learned relationships in the training inputs 202 and/or the actual outputs 210).

The at least one generative AI model may include a number of output layers (e.g., output layer 308, as described below with reference to FIG. 3) that are fine-tuned to specific applications. For example, the output of one or more of the at least one generative AI model can be controlled and guided during a fine-tuning process by introducing task-specific loss functions or constraints, which may be utilized to optimize and specify particular application-specific outputs of the at least one generative AI model. In some implementations, one or more of the at least one generative AI model may be trained using a fine-tuning process to automatically generate database entries or to automatically identify relevant database entries for users based on text input. For example, the one or more of the at least one generative AI model may be utilized to identify or otherwise generate instructions to retrieve data from one or more databases corresponding to user data (e.g., user data stored in at least one of the data repository 132, the memory 126, the memory 155, the accounts database 156, the memory 172, and/or the client application 175, as described herein) associated with a particular user. One or more of the at least one generative AI model may also be fine-tuned to generate, or otherwise select, presentation formats that may be utilized to generate graphical user interfaces (e.g., graphical user interface 600) to display information retrieved from different databases or storage media described herein.

In some embodiments, the at least one generative AI model of the system 200 can be accessed, for example, by the provider computing system 104, the user device(s) 106, and/or the third-party system 108 using at least one communications application programming interface (API). The provider computing system 104 can maintain and provide the at least one communications API. The at least one communications API can be any type of API, such as a web-based API corresponding to a particular network address uniform resource identifier (URI), or uniform resource locator (URL), among others. The at least one communications API can be accessed, for example, by one or more of the provider computing system 104, the user device 106, and/or the third-party system 108, via the network 110. The at least one communications API can be a client-based API, a server API (SAPI), or an Internet Server API (ISAPI). Various protocols may be utilized to access the at least one communications API, including a representational state transfer (REST) API, a simple object access protocol (SOAP) API, a Common Gateway Interface (CGI) API, or extensions thereof. The at least one communications API may be implemented in part using a network transfer protocol, such as the hypertext transfer protocol (HTTP), the secure hypertext transfer protocol (HTTPS), the file transfer protocol (FTP), the secure file transfer protocol (FTPS), each of which may be associated with a respective URI or URL.

Referring to FIG. 3, a block diagram of a simplified neural network model 300 is shown, according to an example embodiment. The neural network model 300 may be implemented and utilized by the AI system 200. The neural network model 300 may include a stack of distinct layers (vertically oriented) that transform a variable number of inputs 302 being ingested by an input layer 301, into an output 306 at the output layer 308. For example, the variable number of inputs 302 may be retrieved from any of the one or more data sources (e.g., the one or more internal data sources and/or the one or more external data sources). As described above, the one or more internal data sources may provide account information associated with a user, a transaction history, and so on. The one or more external data sources may provide parameters surrounding a transaction request (e.g., submitted by a user via the client application 175 on the user device 106), account information (e.g., stored in the accounts database 156), contextual information (e.g., stored in the data repository 132), and so on. The output 306 may include one or more predicted transactions based on the variable number of inputs 302.

The neural network model 300 may include any number of hidden layers 310 between the input layer 301 and output layer 308. Each hidden layer has a respective number of nodes (312, 314 and 316). In the neural network model 300, the first hidden layer 310-1 has nodes 312, and the second hidden layer 310-2 has nodes 314. The nodes 312, 314, and 316 perform a particular computation and are interconnected to the nodes of adjacent layers (e.g., nodes 312 in the first hidden layer 310-1 are connected to nodes 314 in a second hidden layer 310-2, and nodes 314 in the second hidden layer 310-2 are connected to nodes 316 in the output layer 308). Each of the nodes (312, 314 and 316) sum up the values from adjacent nodes and apply an activation function, allowing the neural network model 300 to detect nonlinear patterns in the inputs 302. For example, each of the nodes (312, 314, and 316) may be configured to perform an analysis (e.g., detect patterns, identify trends, perform semantic analysis, etc.) on each of the variable number of inputs 302 (e.g., a transaction history, parameters surrounding a transaction request, account information, contextual information, etc.). Each of the nodes (312, 314 and 316) are interconnected by weights 320-1, 320-2, 320-3, 320-4, 320-5, 320-6 (collectively referred to as weights 320). Weights 320 are tuned during training to adjust the strength of the node. The adjustment of the strength of the node facilitates the neural network's ability to predict an accurate output 306. For example, patterns in a user's transaction history may provide a more accurate indication of a user's future transaction activity than contextual information associated with a particular transaction request. In this example, a node configured to detect patterns in the user's transaction history may be connected to a heavier weight than a node configured to analyze contextual information, therefore increasing the strength of the node that detects patterns in the user's transaction history such that the output 306 is more heavily influenced by the transaction history then the contextual information.

In some embodiments, the output 306 may be one or more numbers. For example, the output 306 may be a vector of real numbers subsequently classified by any classifier. In one example, the real numbers may be input into a softmax classifier. A softmax classifier uses a softmax function, or a normalized exponential function, to transform an input of real numbers into a normalized probability distribution over predicted output classes. For example, the softmax classifier may indicate the probability of the output being in class A, B, C, etc. As, such the softmax classifier may be employed because of the classifier's ability to classify various classes. Other classifiers may be used to make other classifications. For example, the sigmoid function, makes binary determinations about the classification of one class (i.e., the output may be classified using label A or the output may not be classified using label A).

With an example structure of the system 100 being described above, example processes performable by the system 100 (or components/systems thereof) are described below. It should be appreciated that the following processes are provided as examples and are in no way meant to be limiting. Additionally, various method processes discussed herein may be performed in a different order or, in some instances, completely omitted. These variations have been contemplated and are within the scope of the present disclosure.

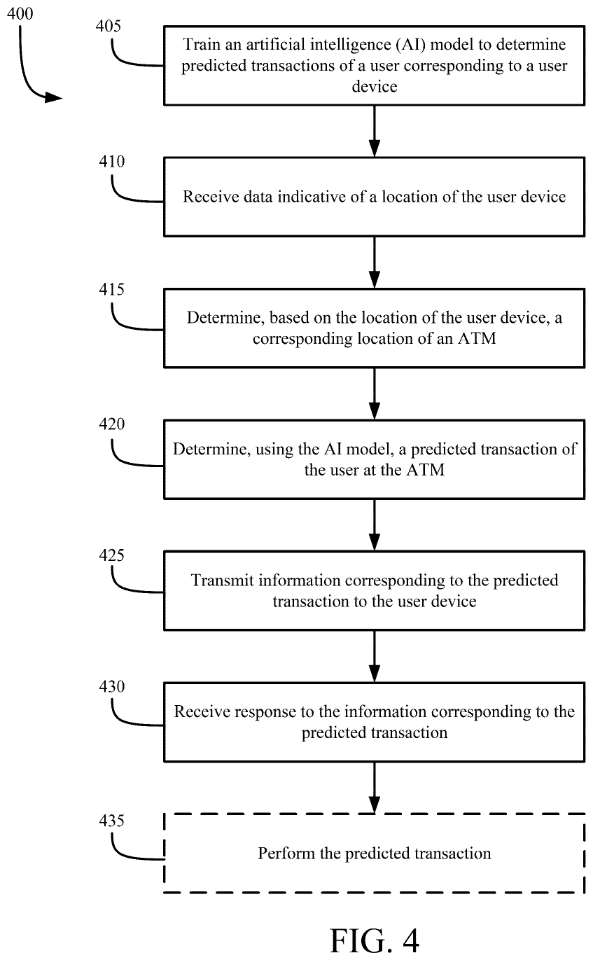

Referring now to FIG. 4, a flow diagram of a method 400 for predicting a transaction for a user to perform at an ATM is shown, according to an example embodiment. Various operations of the method 400 may be conducted by the system 100 and particularly parts thereof (e.g., the ATM computing system 102, the provider computing system 104, the user device 106, and/or the third-party system 108, or a combination thereof).

In some embodiments, the method 400 may begin upon a user accessing the client application 175 from the user device 106. The user may submit at least one authentication credential (e.g., a username, a password, a pin code, a biometric such as a facial scan or a fingerprint, a combination thereof, etc.) to access the client application 175. The client application 175 may, via the network interface circuit 162 of the user device 106, transmit the authentication credential to the provider computing system 104. The provider computing system 104 may validate/verify the authentication credential. In some embodiments, the client application 175 may itself validate/verify the authentication credentials.

In some embodiments, method 400 may include training an artificial intelligence (AI) model to determine predicted transactions of a user corresponding to a user device during process 405. In some embodiments, the AI model may include the machine learning model 204, as described above with reference to FIGS. 2 and 3. The machine learning model 204 may be trained on a subset of data that corresponds to the user accessing the client application 175 from the user device 106. The subset of data may refer to transaction data related to a plurality of transactions of the user with one or more ATMs (e.g., ATM 102). In some embodiments, the transaction data used to train the machine learning model 204 includes information related to the plurality of previous transactions between the user and the one or more ATMs, a transaction frequency for each of the plurality of transactions or a subset of the plurality of transactions, a transaction location and/or time of a transaction for each of the plurality of transactions or a subset of the plurality of transactions, one or more denominations for each of the plurality of transactions or a subset of the plurality of transactions, a currency type for each of the plurality of transactions or a subset of the plurality of transactions, and so on.

After authenticating the user, the provider computing system 104 may be configured to identify a subset of the training data associated with the user, such that the machine learning model 204 may be trained according to that subset of training data associated with the user. For example, the training inputs 202 and/or the actual outputs 210 may be associated with a particular user account and may be tagged so that the data is particular to that user account. The subset of training data associated with the user refers to the training inputs 202 and/or the actual outputs 210 associated with the particular user account. Then, the machine learning model 204 may be trained using the subset of training data such that the trained machine learning model 204 may be configured to generate predictions/recommendations specific to the particular user account. In some embodiments, the subset of training data associated with the user may include data relating to a plurality of transactions of the user with one or more ATMS (e.g., ATM 102) associated with the provider computing system 104.

The method 400 may include process 410, during which the provider computing system 104 receives data indicative of a location of the user device 106 from which the user is accessing the client application 175. In some instances, the client application 175, via the user device 106, may transmit a data payload that includes a location identifier (e.g., GPS information) associated with the user device 106 (e.g., via location-sharing services). In other embodiments, the user, via the client application 175, provides their approximate location. In still other embodiments, the client application 175 or provider computing system may correlate a current location and an expected location of the user to determine/predict where the user is expected to be (e.g., based on a route entered by the user for example to travel to a particular destination).

After receiving the data indicative of the location of the user device 106 during process 410, the provider computing system 104 may determine, based on the location of the user device 106, at least one corresponding location of at least one ATM (e.g., ATM 102) during process 415. In some embodiments, a location of each ATM associated with the provider institution may be stored in the memory 155. The processing circuit 152 of the provider computing system 104 may be configured to identify which ATM associated with the provider institution is in a closest proximity to the location of the user device 106. The closest proximity to the location of the user device 106 may be determined by calculating a distance between the location of the user device 106 and the location of each ATM associated with the provider institution. After determining each distance, the provider computing system 104 may be configured to identify a shortest distance and present the ATM associated with the shortest distance to the user (e.g., via address 615, as described in greater detail below with reference to FIG. 6).

In some embodiments, the provider computing system 104 may determine the corresponding location of the ATM based on a subset of ATMs configured to perform transactions of a transaction type associated with the predicted transaction determined by the machine learning model 204 during process 420, as described in greater detail below.

Alternatively or additionally, the corresponding location of an ATM may be determined based on a preferred ATM designation/indication associated with the user. This preference may be stored in the user account of the user accessing the client application 175 (which may be stored by the provider computing system and/or local in the user device). The preferred ATM may refer to one or more ATMs of a plurality of ATMs associated with the provider computing system 104. In some embodiments, the user may designate the preferred ATM(s) by explicitly indicating the one ATM as the preferred ATM via the client application 175. The preferred ATM(s) may also be automatically identified by the provider computing system 104 based on determining an ATM with which the user most frequently interacts (e.g., if the user interacts more than a predefined amount in a predefined time period with certain ATM(s), then those ATM(s) are automatically identified by the provider computing system to be a preferred ATM(s)). In some embodiments, the provider computing system 104 may be configured to determine the ATM with which the user most frequently interacts by identifying, from a transaction history associated with the user (e.g., stored in the accounts database 156), an ATM involved in a greatest number of transactions included in the transaction history.

In some embodiments, the provider computing system 104 may identify a preferred ATM corresponding to each of a plurality of transaction types. For example, the provider computing system 104 may identify a first preferred ATM for foreign currency withdrawals, a second preferred ATM for domestic currency withdrawals, and so on. The provider computing system 104 may also identify a preferred ATM based on a time of the transaction. For example, the provider computing system 104 may identify, from the transaction history associated with the user, that the user performs a first transaction with a first ATM every Saturday, a second transaction with a second ATM on the first Monday of every month, and so on. In this embodiment, the provider computing system 104 may be configured to store the first ATM as a preferred ATM for transactions on Saturday, the second ATM as a preferred ATM for transactions on the first Monday of every month, and so on.

The method 400 may include process 420, during which the machine learning model 204 determines a predicted transaction of the user at the ATM. In some embodiments, the machine learning model 204 determines the predicted transaction of the user at the ATM responsive to determining that a proximity between the location of the user device 106 and the corresponding location of ATM, determined during process 410, satisfies a threshold criteria. The threshold criteria refers to a predetermined distance (e.g., determined by the provider computing system 104 and/or the ATM computing system 102) within which a user may be configured to perform a transaction with an ATM. For example, the threshold criteria may be one mile, half a mile, two miles, etc. In some embodiments, the threshold criteria may be set based on a number of ATMs associated with the provider institution in a region (e.g., a county, a city, a town, etc.) including the location of the user device 106. For example, the threshold criteria may include a larger distance if the location of the user device 106 is identified in a city that includes ten ATMs associated with the provider institution versus if the location of the user device 106 is identified in a city that includes one ATM associated with the provider institution.

In some embodiments, the predicted transaction of the user at the ATM may be determined based on a time period between a previous instance of the predicted transaction and a current time relative to a frequency of a plurality of previous instances of the predicted transaction. For example, the provider computing system 104 may identify, from the transaction history associated with the user, that the user deposits a check via an ATM at a minimum every X days (e.g., 14 days). If the provider computing system 104 determines that the time period between the previous instance of the transaction (e.g., depositing the check) and the current time at which the user is accessing the client application 175 is X-Y days (e.g., 12 days), the machine learning model 204 may determine that the predicted transaction excludes depositing a check. As another example, the provider computing system 104 may determine, from the transaction history associated with the user, that the user performs a predefined amount withdrawal (e.g., greater than $100) every Saturday morning. Then, the provider computing system 104 may determine that that user is accessing the client application 175 at 8 AM on a Saturday morning. Based on the frequency of the previous instances of the predefined amount withdrawal (e.g., weekly on Saturday), the provider computing system 104 may determine the predicted transaction as the predefined amount withdrawal. That is, the predicted transactions may not only be specific to a particular transaction (e.g., a $40 withdrawal), but may also be specific to ATM locations (e.g., when a user device is determined to be in close proximity to a specific ATM with which the user historically interacts) and time frames (e.g., a user historically interacts with an ATM every Saturday morning), such that the user may receive the predicted transactions at opportune times.

In some embodiments, the corresponding location of the ATM 102 may be determined in response to the machine learning model 204 determining the predicted transaction of the user at the ATM. The provider computing system 104 may be configured to identify a transaction type of the predicted transaction. For example, the transaction type may include a withdrawal of funds, a deposit of funds, a transfer of funds, a deposit of non-monetary media, a balance inquiry, and so on. After determining the transaction type, the provider computing system 104 may determine, from one or more ATMs associated with the provider institution, a subset of ATMs configured to perform transactions of the transaction type. For example, the transaction type may include a withdrawal of foreign currency. In this instance, the provider computing system 104 may identify, from information regarding each ATM associated with the provider institution, a subset of ATMs configured to facilitate the withdrawal of foreign currency (e.g., a subset of ATMs that include a stock of the foreign currency requested for withdrawal). The user may order the foreign currency when prestaging the transaction such that the user may retrieve the foreign currency at a specific ATM. The order for the foreign currency may be processed by the provider computing system 104, and the provider computing system 104 may thereafter initiate a delivery of the foreign currency to that specific ATM. Once the specific ATM receives the delivery of the foreign currency, the user may receive a notification (e.g., via the client application 175 on the user device 106) directing the user to pick up the foreign currency from that ATM.

As another example, if the predicted transaction and/or a transaction request received from the user includes a withdrawal of $500, then the system pre-emptively stages the ATM 102 with large denominations and provides a notification to the customer to visit a certain ATM 102 equipped with the large denominations. In some embodiments, the ATM 102 may have a TCR (teller cash recycler) that automatically knows the denomination make-up. Therefore, this information (e.g., the denomination make-up of cash within the ATM 102) may be transmitted to the provider computing system 104 and communicated to the user device 106 using real-time notifications to the client application 175. For example, if a user prefers to make large denomination withdrawals (e.g., a withdrawal of $1,000 in $100 bills), the provider computing system 104 may be configured to notify the user, via the client application 175 on the user device 106, when the TCR determines that the ATM 102 has a sufficient amount of $100 bills for the user to execute the transaction at that ATM 102.

After identifying the subset of ATMs configured to perform transactions of the transaction type, the provider computing system 104 may be configured to select the ATM 102 from the subset of ATMs based on a distance between the location of the user device 106 and the corresponding location of each ATM included in the subset of ATMs. The distance between the location of the user device 106 and the corresponding location of each ATM included in the subset of ATMs may be determined as described above with reference to process 415.

After determining the predicted transaction during process 420, the method 400 may include process 425 during which the provider computing system 104 transmits information corresponding to the predicted transaction to the user device 106. The information corresponding to the predicted transaction may include one or more parameters associated with the predicted transaction (e.g., an amount, a denomination, a currency, etc.). In some embodiments, the information corresponding to the predicted transaction may be transmitted via graphical user interface 600 (which may be generated and provided by the client application 175, in some embodiments; or, in other embodiments, such as in a web-browsing scenario, the provider computing system may generate and provide the graphical user interface 600), as described below. In some embodiments, the graphical user interface 600 may display one or more elements (e.g., icons, fields, etc.) configured to facilitate casting the predicted transaction to the ATM.

The method 400 may include process 430 during which the provider computing system 104 receives a response to the information transmitted to the user device 106 during process 425. In some embodiments, the response may be received via graphical user interface 600 (e.g., using confirmation element 620), as described below. The response may include an approval from the user to perform the predicted transaction or a denial from the user to perform the predicted transaction.

Depending on the response received during process 430, the provider computing system 104 and/or the ATM computing system 102 may be configured to perform the predicted transaction during process 435. In some embodiments, the provider computing system 104 and/or the ATM computing system 102 may be configured to perform the predicted transaction in response to a signal from the ATM 102 indicating selection of the confirmation element 620, as described in greater detail below with reference to FIG. 6. That is, the user may engage with the confirmation element 620 via a mobile device (e.g., user device 106), and the mobile device (e.g., via the client application 175) may transmit a signal to the ATM 102 indicating that the user has selected the confirmation element 620 and instructing the provider computing system 104 and/or the ATM computing system 102 to perform the transaction. In this way, the signal received from the mobile device replaces the engagement with a display screen of a physical ATM machine that would otherwise instruct the provider computing system 104 and/or the ATM computing system 102 to perform the transaction.

Based on the foregoing, method 400 may be performed in an example operation as follows. The method 400 may begin when a user accesses the client application 175 via a user device 106. The user may receive access to the client application 175 after successfully logging in (e.g., using a username and password, a biometric scan, etc.). The provider computing system 104 may identify that the user device 106 is located at a particular address in a particular location (e.g., Chicago, Illinois) and that a timestamp when the client application 175 is being accessed is a certain day and time (e.g., Friday, Mar. 15, 2024 at 2:32 PM). After identifying this contextual information, the provider computing system 104 may identify that the particular address is X distance (e.g., 0.5 miles) away from an ATM associated with a provider institution that operates the client application 175. Based on a transaction history associated with the user accessing the client application 175 and on the contextual information (e.g., the location of the user device 106 and a date/time at which the client application 175 is accessed), the machine learning model 204 may determine that the user performs a $X (e.g., $200) withdrawal every Friday afternoon. Additionally, the machine learning model 204 may determine that the user requests the $200 withdrawal to be in the form of one $50 bill, five $20 bills, three $10 bills, two $5 bills, and ten $1 bills. Therefore, the machine learning model 204 may determine a predicted transaction for the user with the ATM that is 0.5 miles away for a withdrawal of $200 in the specific denominations of one $50 bill, five $20 bills, three $10 bills, two $5 bills, and ten $1 bills. The transaction information (e.g., the $200 amount, the location of the ATM, and the specific denominations) may be transmitted to the user via a graphical user interface (e.g., graphical user interface 600, as described below) of the user device 106. The user may engage with the graphical user interface (e.g., via the confirmation element 620) to approve the transaction. The ATM computing system 102 may receive an indication of the approval of the transaction from the user. In some embodiments, the ATM computing system 102 may transmit a code to the user upon receiving the indication of the approval of the transaction.

The code may refer to a one-time identifier for the user to input (e.g., via a keypad) on the ATM when the user arrives at the ATM. In some embodiments, the code may include at least one of a QR code, a bar code, a numeric code, an alphabetical code, an alpha-numeric code, etc. Once transmitted to the user, the code may be configured to expire after an amount of time. The amount of time may be a standard period implemented by the provider institution (e.g., two minutes, five minutes, ten minutes, etc.). In some embodiments, the amount of time may depend on the X distance between the user device 106 and the ATM 102. For example, if the X distance between the user device 106 and the ATM 102 is 0.5 miles, the code may be configured to expire after five minutes. As another example, if the X distance between the user device 106 and the ATM 102 is 10 miles, the code may be configured to expire after 30 minutes. In some embodiments, the code may be valid only for use at the ATM 102 identified by the provider computing system 104. In other embodiments, the user may update the ATM 102 with which the user intends to perform the transaction, in which case the provider computing system 104 may be configured to generate and transmit a new code to the user associated with the updated ATM 102 associated with the transaction. Alternatively or additionally, the user may receive an option to confirm arrival at the ATM via the graphical user interface of the user device 106. Once the user indicates that they have arrived at the ATM (e.g., by inputting the code or by confirming via the graphical user interface), the ATM computing system 102 may be configured to perform the transaction and deliver the $200 withdrawal in the form of one $50 bill, five $20 bills, three $10 bills, two $5 bills, and ten $1 bills to the user. Allowing the user to perform the transaction upon submitting a code associated with the transaction prevents the user from having to expose/insert a credit card or other sensitive data directly into the ATM, which enhances the security benefits of performing transactions with a transaction device (e.g., ATM 102).

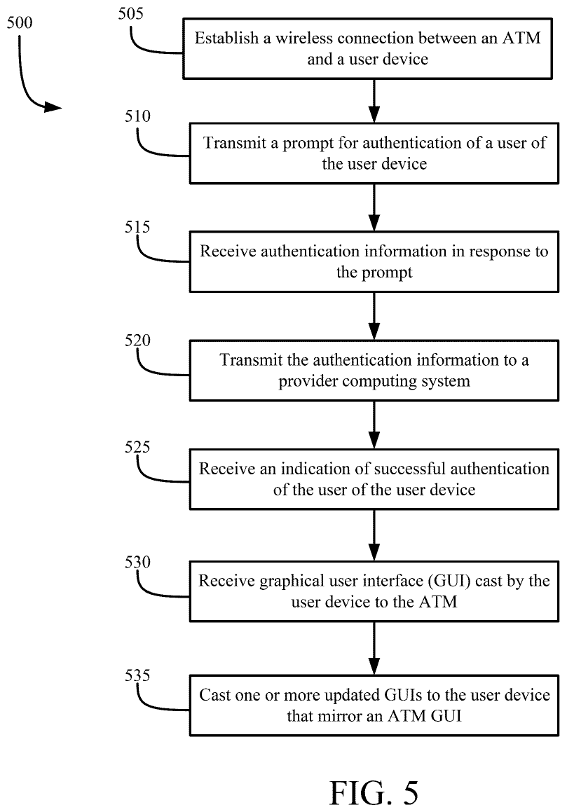

Referring now to FIG. 5, a flow diagram of a method 500 for casting a display between a user device to an ATM is shown, according to an example embodiment. Various operations of the method 500 may be conducted by the system 100 and particularly parts thereof (e.g., the ATM computing system 102, the provider computing system 104, the user device 106, and the third-party system 108).

In some embodiments, method 500 may begin when the ATM computing system 102 establishes a wireless connection between an ATM and a user device (e.g., between the ATM 102 and the user device 106) during process 505. In some embodiments, the ATM computing system 102 may be configured to establish the wireless connection after identifying that a user of the user device 106 has initiated a session via the client application 175 (e.g., a user launches and successfully gains access to the client application 175). For example, the authentication circuit 160 may initiate a near field communication (NFC) between the ATM 102 and the user device 106 of the user once the user successfully accesses the client application 175. Alternatively or additionally, the authentication circuit 160 may require the ATM 102 and the user device 106 be within a proximity of each other (e.g., 10 cm, 20 cm, etc.) in order to process an NFC tap of a token associated with the ATM 102 to the user device 106. In still other embodiments, the authentication circuit 160 may initiate a Bluetooth pairing between the ATM 102 and the user device 106 of the user. As with the NFC communication, the authentication circuit 160 may apply a criteria which includes the ATM 102 and the user device 106 being within a proximity of each other, to pair the user device 106 with the ATM 102. After establishing the wireless connection between the ATM 102 and the user device 106 during process 505, the ATM 102 may be configured to transmit a prompt for authentication of a user of the user device 106 to the user device 106. For example, the authentication circuit 160 may generate a passcode, a username and password combination, a quick access (QR) code, a token, or other suitable authentication credentials specific to the user and/or the transaction request. In some embodiments, the prompt for authentication may include at least one of a push notification, a text message, and email notification, etc.

The method 500 may include receiving, in response to the prompt, authentication information from the user device 106 during process 515. The authentication information may include at least one of a biometric, a personal identification number, a passcode, or a password. The authentication information may be stored in at least one of the memory 126, the accounts database 156, the memory 172, etc. In some embodiments, in addition to receiving authentication information, process 515 may include receiving data corresponding to the user device 106. The provider computing system 104 may be configured to compare the authentication information received by the ATM 102 to the data corresponding to the user device 106. In some embodiments, the authentication information may be compared to a profile linked to the data corresponding to the user device 106 (e.g., at the provider computing system 104). In some embodiments, the profile may be a user profile associated with the user stored in the memory 126 of the ATM computing system 102.

After receiving the authentication information from the user device 106 during process 515, the ATM computing system 102 may be configured to transmit, via the network 110, the authentication information to the provider computing system 104 during process 520. The provider computing system 104 may be configured to authenticate the user of the user device 106, as described above with reference to FIG. 4. The method 500 may include process 525 during which the ATM computing system 102 receives an indication of a successful authentication of the user of the user device 106.

The method 500 may include process 530 in which the ATM computing system 102 receives a graphical user interface (GUI) cast by the user device 106 to the ATM 102 via the wireless connection established during process 505. For example, the user may initiate a transaction via the NFC connection of the user device 106 with the ATM 102, as described above. The ATM computing system 102 may receive the GUI in response to establishing the wireless connection during process 505 and responsive to receiving the indication of successful authentication of the user during process 525. The GUI cast by the user device 106 may include a customized display modified by the user of the user device 106. In some embodiments, the customized display is associated with an account of the user and stored in the accounts database 156. For example, the customized display may include specific ATM features and functions that may be predefined by the user (e.g., a specific GUI layout for ATM interactions, such as the presence or absence of various transaction option icons). In some embodiments, audio assistance may be routed from the ATM 102 via the NFC communication/link with the user device 106, and from the user device 106 to a headset/headphones/speaker/etc. (e.g., via BLUETOOTH or other personal local area network communication).

In some embodiments, the GUI cast to the ATM 102 may include one or more redacted portions such that select information is not displayed on the ATM 102. For example, while displayed via the user device 106, the GUI may include personal identifiable information (PII) (e.g., an account number, a routing number, an address, any other piece of sensitive data, etc.). When the GUI is cast by the user device 106 to the ATM 102, however, the provider computing system 104 may be configured to redact (e.g., censor, obscure, blur, remove, conceal, etc.) the PII originally included on the GUI. This way, the PII is not publicly visible when the GUI is cast from the user device 106 to the ATM 102, and the user's sensitive information is protected.

In some embodiments, the GUI may include the information corresponding to the predicted transaction transmitted to the user device 106 during process 425 of method 400. Alternatively or additionally, the GUI may include a transaction request that is not the predicted transaction (e.g., submitted by the user via the input field 610 of graphical user interface 600, as described below). In some embodiments, the user may be prompted to submit a transaction request after denying (e.g., using confirmation element 620 of graphical user interface 600, as described below) a predicted transaction.

After receiving the GUI from the user device 106 during process 530, the ATM computing system 102 may be configured to cast one or more updated GUIs to the user device 106 that mirror/imitate an ATM GUI during process 535. For example, after a user casts the GUI to the ATM 102 including the transaction information, the ATM 102 may cast one or more updated GUIs to the user device 106 that include follow-up selections, options, questions, etc., associated with the transaction information included in the GUI that the user casts from the user device 106 to the ATM 102. In some embodiments, the ATM 102 may request confidential information (e.g., a PIN code) from the user in order to complete a transaction. Because the GUI is cast on the user device 106, however, the user can submit the confidential information via the GUI on the user device 106, rather than, for example, submitting the confidential information via an exposed display of the ATM 102 and/or sharing the confidential information with a driver of a vehicle if the user is a passenger. In some embodiments, casting one or more GUIs between the user device 106 and the ATM 102 provides a synchronized viewing process between the GUI of the ATM 102 and the GUI of the user device 106, such that the user may view identical displays on the user device 106 and on the ATM 102. In other embodiments, the one or more GUIs cast to the user device 106 may replace the GUI of the ATM 102 such that the transaction may be completed via a GUI on the user device 106, not the ATM 102. With the GUI of the user device 106 replacing the GUI of the ATM 102, the provider computing system 104 limits the user's interaction with the ATM 102 and enhances security measures during a user's interaction with the ATM 102 by displaying sensitive information (e.g., PII, confidential data, etc.) via the user device 106 instead of via the ATM 102.

Based on the foregoing, method 500 may be performed in an example operation as follows. A user may arrive at a location of an ATM 102 (e.g., at the provider institution). The ATM 102 may be configured to establish a wireless connection between the ATM 102 and a user device 106 associated with and proximate to the user who has arrived at the location of the ATM 102. Once the wireless connection is established between the ATM 102 and the user device 106, the ATM computing system 102 may transmit a push notification to the user device 106 prompting the user to submit authentication information to authenticate the user of the user device. In response to the push notification, the user may submit a facial scan via the user device 106 as authentication information, and the ATM computing system 102 may receive the facial scan from the user device 106 via the wireless connection. The ATM computing system 102 may transmit the facial scan to the provider computing system 104 to authenticate the user of the user device 106. For example, the provider computing system 104 may receive the facial scan and may identify that the facial scan corresponds to a profile linked to a user account stored in the accounts database 156. The ATM computing system 102 may receive an indication that the user is successfully authenticated by the provider computing system 104, and the user may thereafter perform a transaction with the ATM 102. From the user device 106, the user may submit a transaction request (e.g., via the input field 610) to deposit a $20 check at the ATM 102 to the user's checking account at the provider institution. The user may indicate the transaction information (e.g., the type of transaction as a deposit of a check, the amount of the transaction as $20, and the account into which the funds are deposited as the user's checking account) from the user device 106 (e.g., via the client application 175 associated with the provider institution). The user may engage with an option (e.g., selectable element 625, as described below) presented via a graphical user interface (e.g., graphical user interface 600) of the user device 106 that allows the user to cast a GUI from the user device 106 to the ATM 102. With the casting option activated, the ATM 102 may be configured to receive the GUI from the user device and cast one or more updated GUIs to the user device that mirror a GUI of the ATM 102. The user may then interact with the one or more updated GUIs to execute a transaction associated with the transaction request. In this example, the ATM 102 may execute the transaction by receiving the $20 check from the user at the ATM 102 and depositing the $20 amount to the user's checking account. The user may instruct the ATM 102 to deposit the $20 amount to the user's checking account (e.g., out of a plurality of accounts associated with the user) via the one or more updated GUIs that the ATM 102 may cast to the user device 106.

Referring to FIG. 6, an example of a potential graphical user interface, graphical user interface 600, which may be presented on the user device 106 by the client application 175 is shown. As shown in FIG. 6, graphical user interface 600 may be associated with a user account of the provider institution. This is a representative, non-limited example interface, and does not necessarily include all potential functionality of various embodiments. Similarly, not all the functionality depicted is necessarily required in all embodiments.

The graphical user interface 600 may include a plurality of selectable elements. In some embodiments, the graphical user interface 600 includes selectable element 605, as depicted in FIG. 6 by a map icon. The selectable element 605 may be configured to allow a user, upon engaging (e.g., clicking on, tapping, selecting, etc.) with the selectable element 605, to view a map including the location of each of the plurality of ATMs associated with the provider institution. In some embodiments, the map may include indications of one or more preferred ATMs, as described above, associated with the user account.

The graphical user interface 600 may display an input field 610. The input field 610 may include a selectable element configured to allow the user of the user device 106 to request a transaction. In some embodiments, the input field 610 may include a free text box in which the user of the user device 106 may be configured to submit one or more parameters of a transaction using a textual entry. For example, the one or more parameters of the transaction may include a transaction type, a transaction amount, a sending party, a receiving party, one or more denominations associated with the transaction, a currency, etc. In some embodiments, after engaging (e.g., clicking on, tapping on, etc.) with the input field 610, the user may receive, via the user device 106, a separate user interface from the graphical user interface 600 that is configured to allow the user to submit the one or more parameters of the requested transaction.

The graphical user interface 600 may display an address 615 associated with an ATM 102. The address 615 associated with the ATM 102 may be provided as a prompt to the user device 106 identifying a nearby ATM 102 for the transaction. In some embodiments, the address 615 may be automatically populated by the provider computing system 104 and may include an address corresponding to the location of the preferred ATM of the user, as described above. Alternatively or additionally, the address 615 may refer to the corresponding location of the ATM determined during process 415 of method 400. In some embodiments, the address 615 may be a hyperlink configured to generate a separate user interface on the user device 106 including directions from the user's location (e.g., the location of the user device 106, as determined during process 410 of method 400) to the address 615.

The graphical user interface 600 may include a confirmation element 620. The confirmation element 620 refers to a selectable element with which a user of the user device 106 can approve or deny a transaction displayed on the graphical user interface 600. The transaction displayed on the graphical user interface 600 refers to at least one of a predicted transaction determined by the machine learning model 204 (e.g., during process 420 of method 400) or a user-entered transaction submitted via the input field 610 of the graphical user interface 600. In some embodiments, as shown in FIG. 6, the confirmation element 620 may include a first selectable element with which the user may approve the transaction and a second selectable element with which the user may deny the transaction.

The graphical user interface 600 may include a selectable element 625 (e.g., a toggle, a button, an icon, etc.). The selectable element 625 may be configured to allow the user of the user device 106 to select whether or not to cast the transaction from the user device 106 to the ATM 102. For example, with the selectable element 625 activated (e.g., indicating that the casting feature is activated), the transaction displayed on the graphical user interface 600 (e.g., the $400 withdrawal as shown in FIG. 6), may be cast to the ATM 102 represented by the address 615. With the selectable element 625 disabled (e.g., indicating that the casting feature is inactivated), the user may need to submit transaction information by interacting with an interface of the ATM 102.

In some embodiments, the graphical user interface 600 depicts one or more recommendations 630. The recommendations refer to predicted preferences of the user regarding the transaction displayed on the graphical user interface 600. As shown in FIG. 6, the one or more recommendations 630 may include one or more suggested denominations. The one or more recommendations 630 may be determined by the machine learning model 204 based on user-specific training data (e.g., a transaction history associated with the user and one or more denominations involved in each transaction included in the transaction history). In some embodiments, the user of the user device 106 may be configured to edit/change/update the one or more recommendations 630. For example, if the machine learning model 204 predicts that the user prefers a $400 withdrawal as two $100 bills, two $50 bills, and five $20 bills, but the user requires smaller denominations for this withdrawal, the user can edit the one or more recommendations 630 to include one $100 bill, two $50 bills, and ten $20 bills via the graphical user interface 600.

The graphical user interface 600 may depict a subsequent transaction 635. The subsequent transaction 635 refers to a next transaction in a scheduled pattern of transactions associated with the transaction displayed via the graphical user interface 600. For example, if the transaction displayed via the graphical user interface 600 includes a predicted transaction (e.g., a $400 withdrawal) determined by the machine learning model 204 after identifying that the user performs the predicted transaction (e.g., the $400 withdrawal) at a regular frequency (e.g., on the first Monday of every month), the graphical user interface 600 may display the next predicted transaction in the regular frequency.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings. Further, the features present in one drawing may be combined, included, or otherwise interoperated with the features disclosed in another drawing.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include machine-readable media for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

The “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may comprise or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud-based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud-based server). To that end, a “circuit” as described herein may include components that are distributed across one or more locations.

An exemplary system for implementing the overall system or portions of the embodiments might include general-purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions comprise, for example, instructions and data which cause a general-purpose computer, special-purpose computer, or special-purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick, or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A computing system, comprising:
one or more automated teller machines (ATMs); and
a provider computing system comprising:
a communication interface configured to communicate with the one or more ATMs and a user device; and
at least one processing circuit coupled to the communication interface, the at least one processing circuit comprising at least one processor coupled to at least one memory device, the at least one memory device storing instructions thereon that, when executed by the at least one processor, cause the at least one processing circuit to:
train, for a user corresponding to the user device, an artificial intelligence (AI) model to determine predicted transactions of the user, using transaction data related to a plurality of transactions of the user with the one or more ATMs associated with the provider computing system;
receive, via the communication interface from the user device, data indicative of a location of the user device;
determine, based on the data indicative of the location of the user device, a corresponding location of an ATM of the one or more ATMs;
determine, using the AI model, a predicted transaction of the user at the ATM, responsive to determining that a proximity between the location of the user device and the corresponding location of the ATM satisfies a threshold criteria; and
transmit, via the communication interface, information corresponding to the predicted transaction to the user device, the user device displaying a user interface including an interface element to cast the predicted transaction to the ATM;
wherein the ATM is configured to:
receive, from the user device, transaction data cast by the user device to the ATM; and
execute a transaction according to the transaction data cast from the user device to the ATM.

2. The computing system of claim 1, wherein the ATM is further configured to:
establish a wireless connection between the ATM and the user device; and
authenticate the user of the user device;
wherein the transaction data is received responsive to establishing the wireless connection and authenticating the user.

3. The computing system of claim 2, wherein, to authenticate the user of the user device, the ATM is further configured to:
transmit, to the user device, a prompt for authentication information in response to establishing the wireless connection;
receive, from the user device, the authentication information in response to the prompt;
transmit the authentication information to the provider computing system for authenticating the user of the user device; and
receive, from the provider computing system, an indication of successful authentication of the user of the user device based on the authentication information.

4. The computing system of claim 3, wherein the instructions further cause the at least one processing circuit to:
receive, from the ATM, the authentication information and data corresponding to the user device; and
authenticate the user of the user device based on a comparison of the authentication information received from the ATM to a profile linked to the data corresponding to the user device.

5. The computing system of claim 1, wherein the transaction data used to train the AI model comprises information related to, for a plurality of previous transactions between the user and the one or more ATMs, a transaction frequency, a transaction location, one or more denominations, and a currency type.

6. The computing system of claim 1, wherein the predicted transaction of the user at the ATM is determined based on a time period between a previous instance of the predicted transaction and a current time and a frequency of a plurality of previous instances of the predicted transaction, wherein the frequency of the plurality of previous instances of the predicted transaction is determined based on a transaction history associated with the user.

7. The computing system of claim 1, wherein, to determine the corresponding location of the ATM, the instructions further cause the at least one processing circuit to:
identify a transaction type of the predicted transaction;
determine, from the one or more ATMs, a subset of ATMs configured to perform transactions of the transaction type; and
select the ATM from the subset of ATMS based on a distance between the location of the user device and the corresponding location of the ATM.

8. The computing system of claim 7, wherein, to direct the user of the user device to the ATM selected, the instructions further cause the at least one processing circuit to:
transmit the corresponding location of the ATM to the user device.

9. The computing system of claim 1, wherein the transaction data corresponds to at least one of the predicted transaction or a transaction which is different from the predicted transaction.

10. A method comprising:
training, by a provider computing system for a user corresponding to a user device, an artificial intelligence (AI) model to determine at least one predicted transaction of the user using transaction data related to a plurality of transactions of the user with one or more automated teller machines (ATMs) associated with the provider computing system;
receiving, by the provider computing system and via a communication interface from the user device, data indicative of a location of the user device;
determining, by the provider computing system and based on the data indicative of the location of the user device, a corresponding location of an ATM;
determining, by the provider computing system using the AI model, a predicted transaction of the user at the ATM responsive to determining that a proximity between the location of the user device and the corresponding location of the ATM satisfies a threshold criteria;
transmitting, by the provider computing system via the communication interface, information corresponding to the predicted transaction to the user device thereby causing the user device to display a user interface including an interface element to cast the predicted transaction to the ATM; and
performing, by the provider computing system responsive to a signal from the ATM indicating selection of the interface element, the predicted transaction.

11. The method of claim 10, further comprising:
transmitting, by the provider computing system via the communication interface, a prompt for authentication information to the user device;
receiving, by the provider computing system via the communication interface from the user device, the authentication information and data corresponding to the user device; and
authenticating, by the provider computing system, the user of the user device based on a comparison of the authentication information to a profile linked to the user device.

12. The method of claim 10, wherein the transaction data used to train the AI model comprises information related to, for a plurality of previous transactions between the user and the one or more ATMs, a transaction frequency, a transaction location, one or more denominations, and a currency type.

13. The method of claim 10, wherein the predicted transaction of the user at the ATM is determined based on the proximity, a time period between a previous instance of the predicted transaction and a current time, and a frequency of a plurality of previous instances of the predicted transaction, wherein the frequency of the plurality of previous instances of the predicted transaction is determined based on a transaction history associated with the user.

14. The method of claim 10, further comprising:
identifying, by the provider computing system, a transaction type of the predicted transaction;
determining, by the providing computing system, a subset of ATMs from the one or more ATMs configured to perform transactions of the transaction type; and
selecting, by the provider computing system, the ATM from the subset of ATMs based on a distance between the location of the user device and the corresponding location of the ATM.

15. The method of claim 14, further comprising:
transmitting, by the provider computing system via the communication interface, the corresponding location of the ATM to the user device to direct the user of the user device to the ATM selected.

16. The method of claim 10, wherein the transaction data corresponds to at least one of the predicted transaction or a transaction which is different from the predicted transaction.

17. A provider computing system, comprising:
a communication interface configured to communicate with a user device; and
at least one processing circuit coupled to the communication interface, the at least one processing circuit comprising at least one processor coupled to at least one memory device, the at least one memory device storing instructions thereon that, when executed by the at least one processor, cause the at least one processing circuit to:
train, for a user corresponding to the user device, an artificial intelligence (AI) model to determine predicted transactions of the user using transaction data related to a plurality of transactions of the user with one or more automated teller machines (ATMs);
receive, from the user device, data indicative of a location of the user device;
determine, based on the data indicative of the location of the user device, a corresponding location of an ATM;
determine, using the AI model, a predicted transaction of the user at the ATM responsive to determining that a proximity between the location of the user device and the corresponding location of the ATM satisfies a threshold criteria;
transmit information corresponding to the predicted transaction to the user device, the user device displaying a user interface including an interface element to cast the predicted transaction to the ATM; and
perform, responsive to a signal from the ATM indicating selection of the interface element, the predicted transaction.

18. The provider computing system of claim 17, wherein the at least one processing circuit is further configured to:
transmit, via the communication interface, a prompt for authentication information to the user device;
receive, via the communication interface from the user device, the authentication information and data corresponding to the user device; and
authenticate the user of the user device based on a comparison of the authentication information to a profile associated with the user device.

19. The provider computing system of claim 17, wherein the at least one processing circuit is further configured to:
identify a transaction type of the predicted transaction;
determine a subset of ATMs from the one or more ATMs configured to perform transactions of the transaction type; and
select the ATM from the subset of ATMs based on a distance between the location of the user device and the corresponding location of the ATM.

20. The provider computing system of claim 19, wherein the at least one processing circuit is further configured to:
transmit, via the communication interface, the corresponding location of the ATM to the user device to direct the user of the user device to the ATM selected.
